(19) United States
(12) Patent Application Publication
(10) Pub. No.: US 2004/0118655 A1
(43) Pub. Date: Jun. 24, 2004

(54) Torque transmission arrangement

(75) Inventors: Thomas Dogel, Bad Kissingen (DE); Igor Kister, Wurzburg (DE); Reinhard Feldhaus, Niederwerrn (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/689,766

(22) Filed: Oct. 21, 2003

(30) Foreign Application Priority Data
Oct. 22, 2002 (DE) 102 49 061.9
Sep. 24, 2003 (DE) 103 44 124.7

(51) Int. Cl. F16D 21/06

(52) U.S. Cl. 192/48.8; 192/55.61; 192/87.11

(57) ABSTRACT

A torque transmission arrangement includes a torsional-vibration damper arrangement having a primary side for fixing to a drive member and a secondary side rotatable about an axis of rotation (A) with respect to the primary side counter to the action of a damper element arrangement. A double clutch arrangement is coupled to the secondary side of the torsional-vibration damper arrangement and has a first clutch region for selective torque transmission coupling to a first output member and a second clutch region for selective torque transmission coupling to a second output member. A selectively activatable rotary-state influencing arrangement can limit the rotational movement of the secondary side with respect to the primary side and/or to a subassembly essentially nonrotatable about the axis of rotation (A).

### BACKGROUND OF THE INVENTION

1. Field of the Invention

The present invention relates to a torque transmission arrangement comprising a torsional-vibration damper arrangement with a primary side to be tied up to a drive member and with a secondary side rotatable about an axis of rotation with respect to the primary side counter to the action of a damper element arrangement, and a double clutch arrangement which is coupled to the secondary side of the torsional-vibration damper arrangement and which has a first clutch region for selective torque transmission coupling to a first output member and a second clutch region for selective torque transmission coupling to a second output member.

2. Description of the Related Art

When torsional-vibration dampers, constructed, for example, as what are known as two-mass flywheels, are used in drive trains of motor vehicles, there is the fundamental problem that torsional-vibration dampers of this type pass through a resonant range particularly when a drive assembly is being started or stopped. In this case, excessive vibration amplitudes of the primary side and secondary side, which rotate with respect to one another, may arise, which, on the one hand, become noticeable as unpleasant noises, but, on the other hand, subject various regions or components of the drive train to high load.

In order to prevent the occurrence of vibrations of this kind or to mitigate the vibration amplitude, it is known to use in torsional-vibration damper arrangements frictional devices which have a permanent or protracted action, but have the disadvantage that they take effect in the entire rotational-speed range. Furthermore, it is known, when a specific relative rotational acceleration between the primary side and the secondary side is exceeded, to bring at least one of the clutch regions of a double clutch arrangement into a slipping state, that is to say to provide a frictional device which acts on the secondary side and in the region of which vibrational energy is dissipated by sliding friction.

U.S. Pat No. 5,667,047 discloses the combination of a flywheel with a conventional single clutch, in which combination a frictional device is provided, which can be activated in predetermined operating states by means of an actuating system of the friction clutch.

### SUMMARY OF THE INVENTION

The object of the present invention is to provide an initially mentioned torque transmission arrangement with a torsional-vibration damper arrangement and with a double clutch arrangement, in which measures for the prevention of excessive vibration amplitudes are provided.

This object is achieved, according to the invention, by means of a torque transmission arrangement comprising a torsional-vibration damper arrangement with a primary side to be tied up to a drive member and with a secondary side rotatable about an axis of rotation with respect to the primary side counter to the action of a damper element arrangement, and a double clutch arrangement which is coupled to the secondary side of the torsional-vibration damper arrangement and which has a first clutch region for selective torque transmission coupling to a first output member and a second clutch region for selective torque transmission coupling to a second output member, and also a selectively activatable rotary-state influencing arrangement for the secondary side for influencing the rotational movement of the latter with respect to the primary side and/or to a subassembly essentially nonrotatable about the axis of rotation.

The provision of a selectively activatable rotary-state influencing arrangement for the secondary side ensures, even in the case of the combination of a torsional-vibration damper arrangement with a double clutch arrangement, that, above all, during passage through the resonant frequency or the resonant range, excessive vibration amplitudes of the relative vibration between the primary side and the secondary side do not occur. In phases in which excessive vibrations of this type are not to be expected, the rotary-state influencing arrangement may be deactivated or activated with reduced effectiveness, in order to achieve improved torsional-vibration uncoupling in these states. In this state, it is then possible, furthermore, to damp the vibrations still transmitted via the torsional-vibration damper arrangement, for example by means of at least one clutch region which is in the slipping state.

The double clutch arrangement according to the invention may be constructed with an input region coupled to the secondary side and comprising a first pressure plate and an abutment region of the first clutch region and a second pressure plate and an abutment region of the second clutch region, and with an output region comprising a clutch disk arrangement of the first clutch region, which can be coupled fixedly in terms of rotation to the first output member, and a clutch disk arrangement of the second clutch region, which can be coupled in terms of rotation to the second output member. A first actuating system is assigned to the first clutch region, and a second actuating system is assigned to the second clutch region.

In order to keep the construction of the arrangement according to the invention as simple as possible, it is proposed that the rotary-state influencing arrangement be actuable by the first actuating system and/or the second actuating system and/or comprise parts thereof. Here, therefore, there is, with regard to specific parts, a fusion of parts or of functions which leads to a comparatively simple and therefore also operationally reliable construction of the entire system.

So that the activation of the rotary-state influencing arrangement and its deactivation can be carried out by means of at least one of the first and second actuating systems, while influencing the assigned clutch region or the assigned pressure plate in the necessary way by means of this actuating system, it is proposed that, for the actuation of the rotary-state influencing arrangement, the first actuating system and/or the second actuating system be capable of being brought into a regulating state which lies outside a regulating range provided for adjusting the assigned pressure plate between an engagement position and a disengagement position.

In the arrangement according to the invention, the construction may further be such that the actuating system assigned to the first clutch region includes a force application arrangement which is arranged on one axial side of the abutment region, this axial side being opposite the positioning of the first pressure plate with respect to the abutment region of the first clutch region, and includes an actuating-force transmission arrangement for transmitting an actuating force from the force application arrangement to the first pressure plate. The actuating-force transmission arrangement or an element coupled to it and/or the force application arrangement or an element coupled to it are capable, for influencing the rotation of the secondary side, of being brought into interaction with the primary side and/or with a subassembly essentially nonrotatable about the axis of rotation.

In an alternative embodiment, it is proposed that the rotary-state influencing arrangement be actuable by a third actuating system designed separately from the first actuating system and the second actuating system. In an arrangement of this type, therefore, the rotary-state influencing arrangement can be actuated completely independently of whether and how the two clutch regions are actuated by the activating systems assigned in each case to them, the range of use of the arrangement being markedly broadened. In this case, for example, there may be provision for the third actuating system to comprise an actuating-force transmission member essentially axially bridging the double clutch arrangement and capable of being acted upon by an actuator region.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a longitudinal section of a double clutch arrangement in conjunction with a torsional-vibration damper arrangement;

FIGS. 2A-2C show various operating states of a clutch disk designed with lining springing;

FIG. 3 is a partial longitudinal section view, corresponding to FIG. 1, of an embodiment of a torque transmission arrangement according to the invention;

FIG. 4 is an axial view of a thrust ring used in the arrangement illustrated in FIG. 3;

FIG. 5 is a side view of the portion illustrated by a wavy line in FIG. 4, in the viewing direction V;

FIG. 6 is a partial longitudinal section view of a second embodiment;

FIG. 7 is a partial longitudinal section view of a third embodiment;

FIG. 8 is a view of a detail of components coming frictionally into interaction with one another;

FIG. 9 is a partial longitudinal section view of a fourth embodiment;

FIG. 10 is a partial longitudinal section view of a fifth embodiment;

FIG. 11 is a partial axial view of a force application arrangement used in the arrangement in FIG. 10 and designed as a diaphragm spring;

FIG. 12 is a partial axial view an alternative embodiment of a force application arrangement; and

FIG. 13 is a partial longitudinal section view of a sixth embodiment torque transmission arrangement according to the invention.

### DETAILED DESCRIPTION OF THE PRESENTLY PREFERRED EMBODIMENTS

FIG. 1 illustrates diagrammatically a torque transmission arrangement 10 which has essentially two regions. These are, on the one hand, a torsional-vibration damper arrangement 12 and, on the other hand, a double clutch arrangement 14. By means of this torque transmission arrangement 10, a drive torque can be transmitted selectively between a drive shaft 16, for example the crankshaft of an internal combustion engine, and one of two transmission input shafts 18, 20 arranged coaxially to one another, these shafts 16, 18, 20 being rotatable about an axis of rotation A.

The torsional-vibration damper arrangement 12 comprises a primary side 22 coupled or couplable to the drive shaft 16 and a secondary side 24. In the example illustrated diagrammatically in FIG. 1, the primary side 22, in turn, comprises two cover disk elements 26, 28 which lie at an axial distance from one another and between which a central disk element 30 of the secondary side 24 engages. The central disk element, in turn, is coupled to an input region 32 of the double clutch arrangement 14. The cover disk elements 26, 28 are coupled in torque transmission terms to the central disk element 30 via a plurality of damper spring elements 34, so that, under the compression of the torsional damper springs 34, oriented, for example, in the tangential direction with respect to the axis of rotation A, but, in a corresponding embodiment, also being positionable radially, the primary side 22 and the secondary side 24 can rotate about the axis of rotation A with respect to one another. The torsional-vibration damper arrangement 12 is thus designed essentially as what is known as a two-mass flywheel.

The double clutch arrangement 14 comprises two clutch regions 36, 38. The input region 32 of the double clutch arrangement 14 comprises, in assignment to the first clutch region 36, a first pressure plate 40 and, axially opposite the latter, an abutment plate 42 which on one axial side provides an abutment region of the first clutch region 36. Furthermore, this abutment plate 42 of the input region 32 is also coupled to the central disk element 30 of the secondary side 24 of the torsional-vibration damper arrangement 12.

The input region 32 comprises, in assignment to the second clutch region 38, a second pressure plate 44 and, axially opposite the latter, again the abutment plate 42 which, with its side facing the pressure plate 44, forms the abutment region for the second clutch region 38. That is to say, the abutment plate 42 thus forms the abutment arrangement or the abutment regions for the two clutch regions 36, 38 and is positioned between the two pressure plates 40, 44.

An output region 46 of the double clutch arrangement 14 comprises, in assignment to the first clutch region 36, a first clutch disk 48 and, in assignment to the second clutch region 38, a second clutch disk 50. While the clutch disk 48 lies axially with its friction linings 52 between the first pressure plate 40 and the abutment plate 42, the clutch disk 50 lies axially with its friction linings 54 between the second pressure plate 44 and the abutment plate 42. Furthermore, the clutch disk 48 of the first clutch region 36 is coupled or couplable fixedly in terms of rotation to the transmission input shaft 18. The clutch disk 50 of the second clutch region 38 is coupled or couplable fixedly in terms of rotation to the transmission input shaft 20.

Furthermore, a first actuating system 56 and a second actuating system 58 are provided in assignment to the two clutch regions 36, 38 respectively. The first actuating system 56 comprises a force application arrangement 60 which in a radially outer region acts on an actuating-force transmission arrangement 62 coupled in force transmission terms to the first pressure plate 40 and bridging the abutment plate 42. The force application arrangement 60 may comprise a plurality of actuating-force transmission lever elements which may be coupled to one another successively in the circumferential direction and which make essentially no contribution to the intrinsic force. Radially further inward, the force application arrangement 60 is supported axially on a housing region 64 of the input region 32 via a supporting arrangement 64. At the radially inner region, an actuator mechanism 66 engages on the force application arrangement 60, so that, in the event of the displacement of the radially inner region of this force application arrangement, the latter being supported in the radially middle region on the housing 64, its radially outer region is moved to the right in the illustration of FIG. 1. At the same time, the actuating-force transmission arrangement 62 and consequently also the pressure plate 40 are moved to the right, so that the first clutch region 36 is engaged. This movement of the pressure plate 40 may take place counter to the action of force of a restoring element arrangement 68, comprising, for example, a plurality of tangential leaf springs or the like, which ensures that the pressure plate 40 is transferred into the disengagement state when the actuator mechanism 66 releases the force application element 60.

Four actuating or regulating states of the actuating system 56 of the first clutch region 36 are illustrated in FIG. 1. The regions marked by the dotted line C and the dashed line D define that regulating or pivoting or displacement range which is necessary in order to adjust the clutch region 36 between a fully engaged and a fully disengaged state. The regulating state marked by B in FIG. 1 and actually illustrated lies outside this normal regulating range and can be assumed under the action of the restoring element arrangement 68, which displaces the pressure plate 40 and the actuating-force transmission arrangement 62 away from the abutment plate 42 and beyond the fully uncoupled position to an extent such that even the force application arrangement 60, which essentially does not make any intrinsic force contribution, is pivoted correspondingly, this also becoming possible in that the actuator mechanism 66 is brought into a position drawn correspondingly far back. However, this position B may also be assumed in that the force application arrangement 60 or the lever elements of the latter are pivoted actively by the actuator mechanism 66 being drawn back or correspondingly activated, and, at the same time, in that the actuating-force transmission arrangement 62 and therefore the pressure plate 40 are displaced correspondingly by action upon a stop region 70.

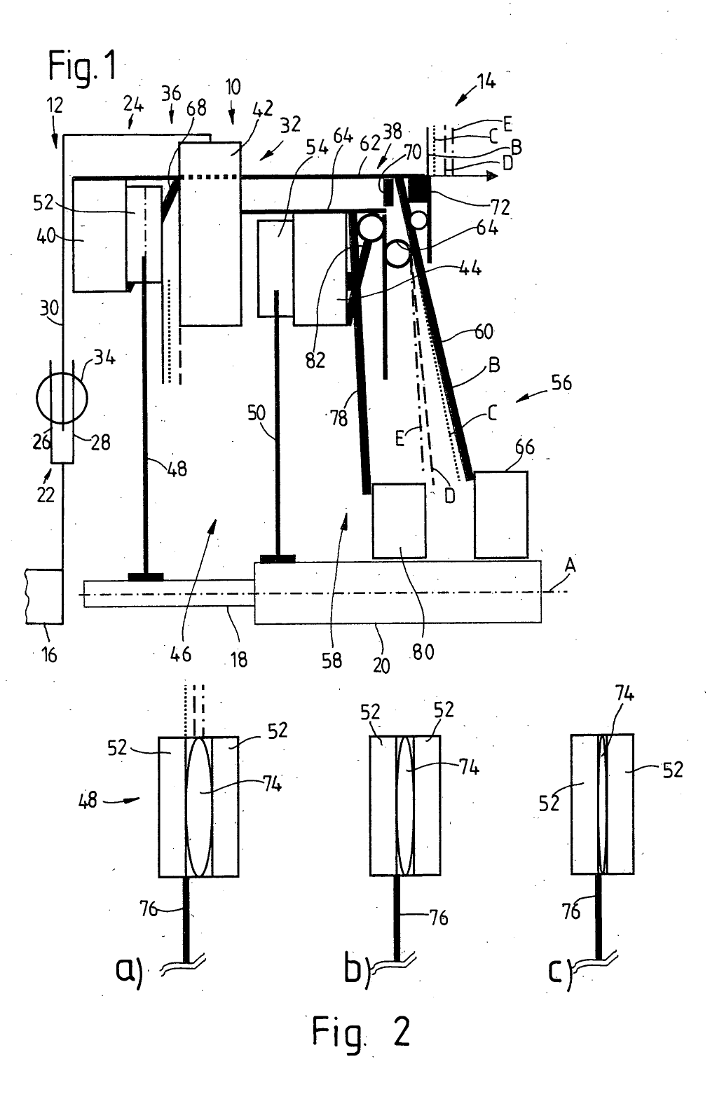

What is achieved by the force application arrangement 60 being pivoted beyond the position D to the position E by the action of the actuator mechanism 66 is that, with the radially outer region of the force application arrangement 60 acting upon a stop region 72 on the actuating-force transmission arrangement 62, the latter and consequently also the pressure plate 40 of the first clutch region 36 are displaced in the direction to the right in FIG. 1, that is to say the pressure plate 40 is displaced in the direction of the abutment plate 42. So that it can become possible for the pressure plate 40 or the actuating-force transmission arrangement 62 to be displaced beyond the fully engaged position here, the clutch disk 48 is designed in such a way that some axial compressibility is provided. This is illustrated in the diagrams of FIGS. 2A-2C which illustrate the radially outer region of this clutch disk 48. The friction linings 52 of the latter are fixed to a carrier element 76 in a way known per se via a lining springing 74, and this lining springing may be designed, for example, as what is known as double-D springing which allows a comparatively high axial stroke. FIG. 2A) in this case shows the relaxed state, that is to say also the state which can be seen in FIG. 1, in which the friction linings 52 of the clutch disk 48 are not clamped between the pressure plate 40 and the abutment plate 42. FIG. 2B) illustrates the state in which, after the corresponding activation of the actuator mechanism 66 and after the regulating state D is reached, the first clutch region 36 is fully engaged and, as can be seen, the lining springing, correspondingly approaching the frictional linings 52, is compressed correspondingly. During further movement into the regulating state E, the lining springing is then compressed even further, as can be seen in FIG. 2C), this entailing a further approach of the pressure plate 40 to the abutment plate 42 and a corresponding displacement of the actuating-force transmission arrangement 62 in the axial direction, the engagement state of the first clutch region 36 being maintained.

The above-described activation or adjustment of the first actuating system 56 of the first clutch region 36 in order to assume the state B and/or assume the state E may be utilized according to the invention, as described in more detail below, for influencing the rotational behavior of the secondary side 24 of the torsional-vibration damper arrangement 12 or else of the input region 32 of the double clutch arrangement 14 and thus, for example, for preventing the occurrence of resonant vibrations during passage through the resonant range of the torsional-vibration damper arrangement 12.

In the first place, it may also be stated that the second actuating system 58, too, comprises a force application arrangement 78 which comprises, for example, a plurality of actuating lever elements and which is supported in its radially outer region with respect to the housing 64, acts radially further inward upon the second pressure plate 44 of the second clutch region 38 and radially on the inside is under the action of an actuator mechanism 80. For the second pressure plate 44 too, a restoring element arrangement 82, for example, again, a tangential leaf spring arrangement, is provided, in order, when the force application arrangement 78 is released by the actuator mechanism 80, to ensure that the pressure plate 44 is moved in the direction away from the abutment plate 42.

As described above, it is, of course, possible, in the case of at least one of the clutch regions 36, 38, to use diaphragm springs or the like instead of the force application arrangements 60, 78 referred to above as making no intrinsic force contribution, so that, in contrast to the illustrated clutch regions of the normally open type, at least one clutch region is then designed as a normally closed clutch region. The actuator mechanisms 66 or 80 then do not deliver any engagement forces, but, in counteraction to the force of the respective force accumulator, disengagement forces instead.

It may be pointed out, further, that the positions E and B may be reached not only by the restoring forces already referred to above, which can be achieved by means of any spring elements, but, of course, also in that the actuator mechanism 66 can engage in force transmission terms in both directions on the force application arrangement 60, in order both to press the latter into the position E and to draw the latter into the position B.

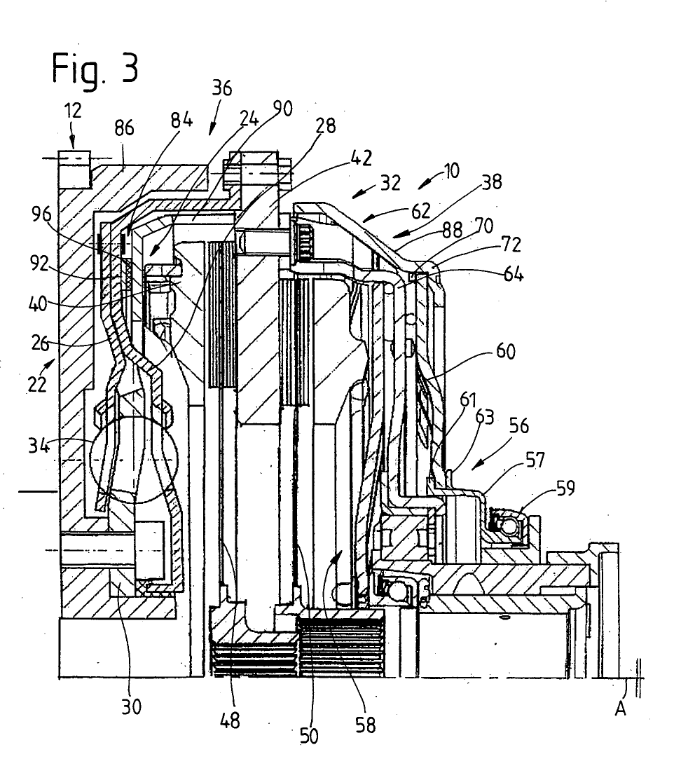

FIG. 3 shows an embodiment of a torque transmission arrangement 10, in which, since the actuating-force transmission arrangement 62 of the latter assumes the position D designated in FIG. 1, a frictional device 84 is not activated and the clutch region 36 is in the torque transmission state. The basic construction of this torque transmission arrangement 10 corresponds to that described above. It may be pointed out, in particular, that, in the embodiment illustrated in FIG. 3, conversely to the embodiment according to FIG. 1, the central disk element 30, in conjunction with a primary mass part 86, forms the primary side 22 of the torsional-vibration damper arrangement 12, while the two cover disk elements 26, 28 provided as sheet-metal formed parts essentially provide the secondary side 24. In this respect, it may be pointed out, further, that the central disk element 30 is prolonged radially outward beyond its region of interaction with the springs 34 and engages, with arm portions that cannot be seen in FIG. 3, into circumferentially formed clearances in the cover disk elements 26, 28, with the result that rotary angle limitation is at the same time also provided. It can be seen, furthermore, that the actuating-force transmission arrangement 62 comprises two shell-like components 88, 90 which are connected to one another by clamping, soldering, welding or the like, the part 90 which also axially bridges the abutment plate 42 acting on the pressure plate 40 via a wear readjustment device. The construction otherwise corresponds essentially to the above-described construction of FIG. 1.

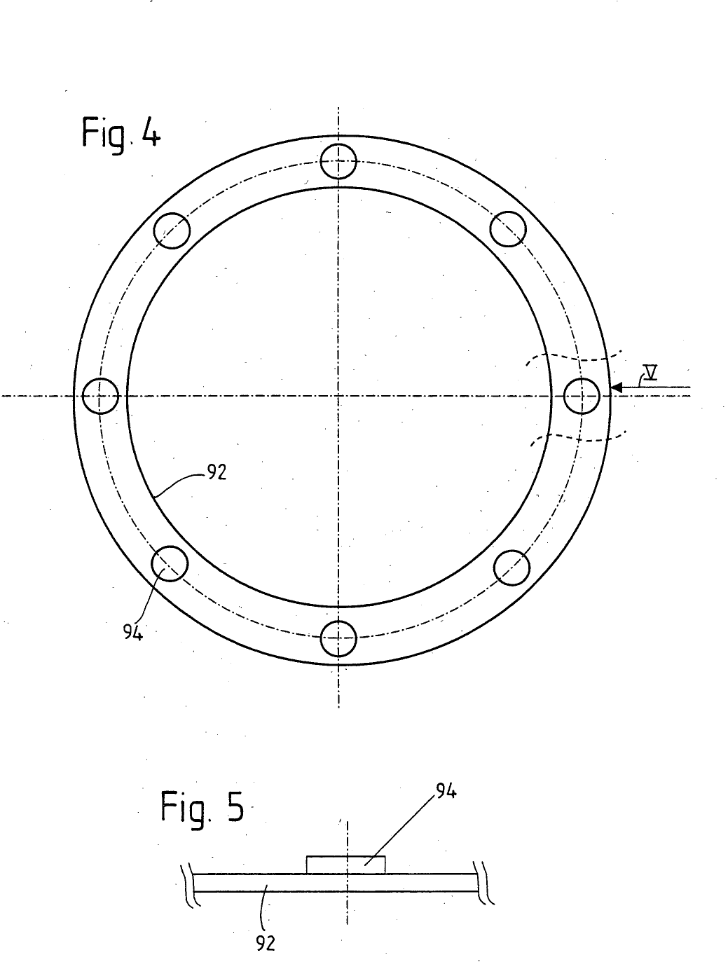

The frictional device 84 providing essentially a rotary-state influencing arrangement for the secondary side 24 comprises a thrust ring 92, as illustrated, for example, in FIG. 4. This thrust ring 92 has, at a plurality of circumferential positions, supporting regions 94, by means of which it is supported or secured on the portions of the central disk element 30 which were referred to above and extend radially outward. This support or securing may take place frictionally, in a materially integral manner or positively, so that, in any event, there is circumferential coupling between the thrust ring 92 and the central disk element 30, that is to say the primary side 22 of the torsional-vibration damper arrangement 12. Furthermore, the frictional device 84 comprises a friction ring 96 which, for example, may be secured to the thrust ring 92 and against which the component 90 of the actuating-force transmission arrangement 62 can come to bear in the event of the corresponding axial displacement of the latter.

Moreover, FIG. 3 shows the two stop regions 70, 72 which ensure that, depending on the application direction of the force application arrangement 60, the latter displaces or acts upon the restoring element arrangement in a corresponding direction. In this case, the stop region 70 may be formed by an insert ring which can engage, for example, into a groove-like indentation, while the stop region 72 may be formed by a bottom region of the shell-like component 88 having a generally pot-like configuration.

Furthermore, it can be seen, at the radially inner region of the force application arrangement 60 that, even there, this force application arrangement 60 cooperates with an output part 57 of an axial bearing 59 of the actuating system 56 for interaction in both axial directions. For this purpose, the part 57 of the force application arrangement 60 may have, at its radially inner region, portions 61, 63 engaging over on the two axial sides and extending radially outward. These may be formed integrally on one and the same component by the provision of tab portions bent correspondingly radially outward. However, at least the portions 61 may be formed on a separate component firmly connected to the component 57.

Thus, when the actuating system 56 is activated or adjusted, if appropriate also under the action of the restoring element arrangement 68 referred to above, in such a way that it assumes the state B, the part 90 of the actuating-force transmission arrangement 62 is moved axially toward the friction ring 96 and thereby activates the frictional device 84, and a frictional force is built up between the primary side 22 of the torsional-vibration damper arrangement 12 and, in the case illustrated, the actuating-force transmission arrangement 62 of the actuating system 56. However, this entire actuating system is basically to be assigned to the input region 32 of the double clutch arrangement 14, which input region is firmly connected, in turn, to the secondary side 24 of the torsional-vibration damper arrangement 12. That is to say, the activation of the frictional device 84 ensures that a relative rotation of the primary side 22 with respect to the secondary side 24 is counteracted. This may be the case, for example, in the starting state during passage through the resonant range of the torsional-vibration damper arrangement 12. After passage through this range and entry into a range in which vibrational excitations of such magnitude are no longer to be expected, by an appropriate activation of the actuating system 56 the latter can be brought into the range C-D again, so that, in particular, the clutch region 36 can be activated again in the conventional way. It goes without saying that, with the force application arrangement 60 being correspondingly supported in terms of force, that is to say, in the example illustrated, by lever elements or the like, on the actuating-force transmission arrangement 62, a force contribution for activating the frictional device 84 can also be made by means of the actuating system 56.

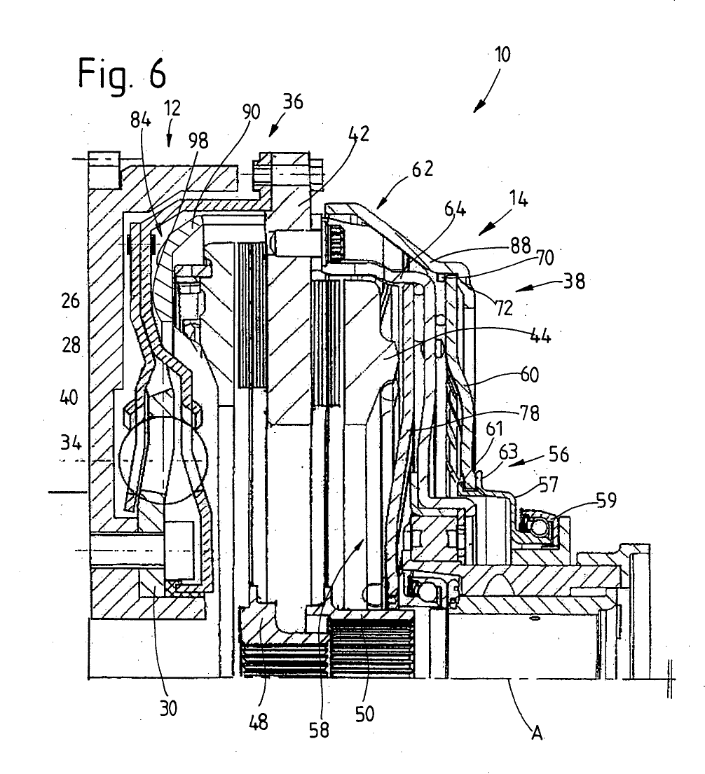

A modification of the embodiment outlined above is shown in FIG. 6. Only the differences are dealt with below. It can be seen here that the part 90 of the actuating-force transmission arrangement 62 forms here, together with a back region 98, a portion of the frictional device 84 which exerts a frictional action and which, for example, can come to bear directly against the portions of the central disk element 30 which cannot be seen in FIG. 6 and which extend radially outward. There may be provision here, therefore, for direct steel/steel contact to be made between the components bearing frictionally against one another. Here, too, it is of course possible to provide a thrust ring 92, as was outlined above.

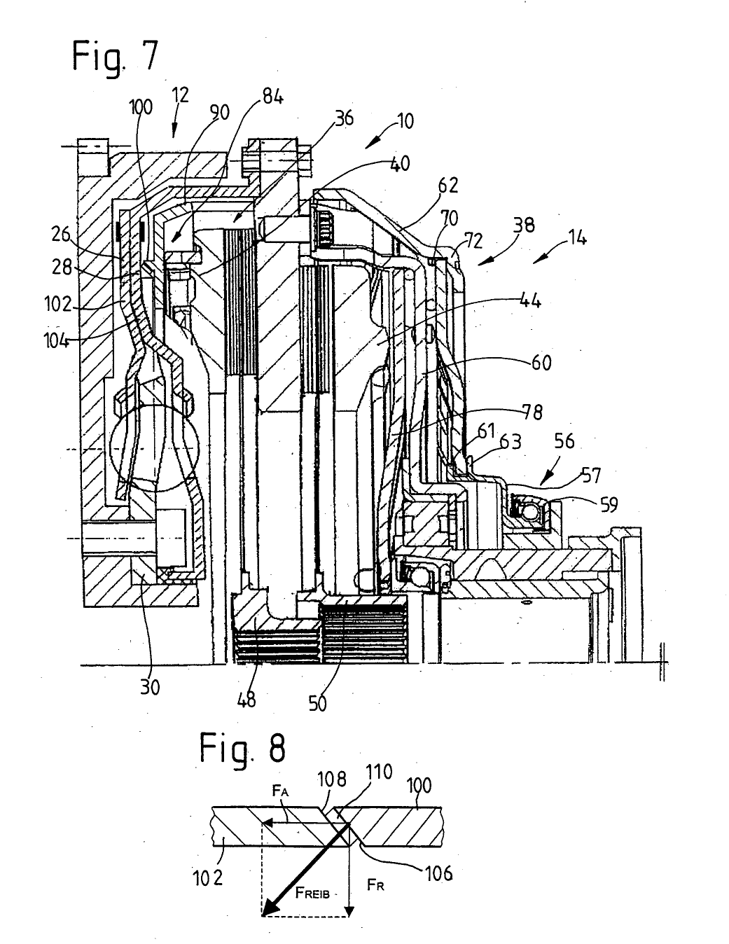

In the design variant illustrated in FIG. 7, the component 90 of the actuating-force transmission arrangement 62 has provided on it a frictional portion 100 of the frictional device 84, opposite which frictional portion is located a counterfrictional portion 102 on the radially outward-extending portions 104 of the central disk element 30. It can be seen, in the enlarged illustration of FIG. 8, that these portions 100, 102 have in the circumferential direction bearing surfaces 106, 108 which run around in a ring-like manner, at least in regions, and are conical (preferably with an angle of 45°), that is to say are inclined to an axial or radial direction, while a friction ring 110 may be provided on one of these bearing surfaces 106, 108. The axial force F_{A} generated during the axial displacement of the actuating-force transmission arrangement 62 generates in this case an additional radial supporting component with a corresponding radial force F_{R}, thus resulting in a frictional force F_{FRIC} which is orthogonal to the two surfaces 106,108 and is greater in terms of amount than the axial force F_{A}. An increase in frictional moment can thus be obtained.

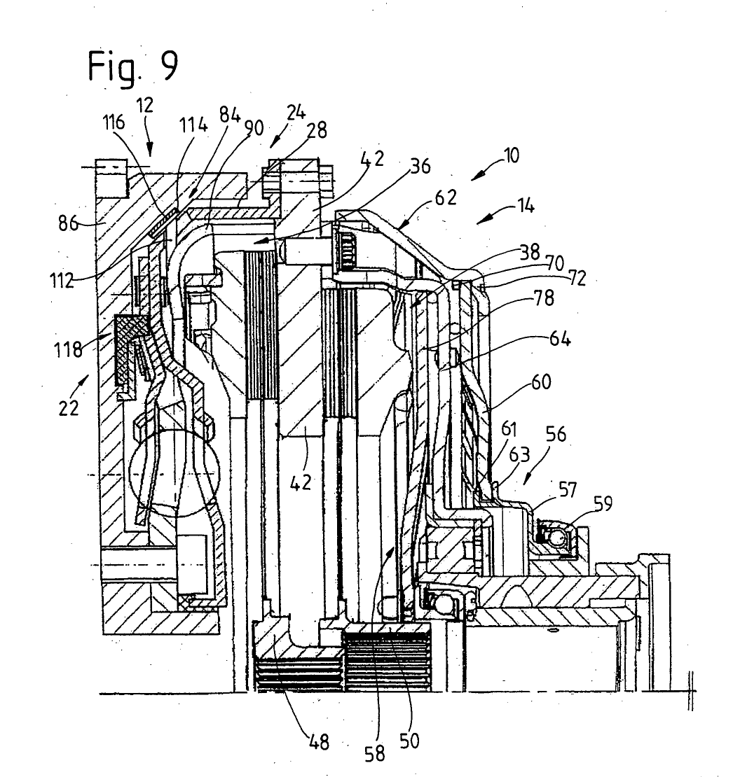

In the embodiment according to FIG. 9, the component 90 of the actuating-force transmission arrangement 62 has provided on it bearing projections 112 which pass through the cover disk element 28 fixed to the abutment plate 42, for example, by bolts. These bearing projections act, for example, upon a thrust ring 114 which, for example, with a friction ring 116 interposed, can press against the primary mass part 86. Here, too, there is again an oblique position of the surfaces coming frictionally into interaction with one another, along with the above-mentioned effect of an increase in frictional force. It can be seen, further, that this arrangement can cause a radially outward displacement of the frictionally active surface, with the result that an increase in frictional moment can additionally be introduced.

Both in the above-described embodiments and in the embodiment shown in FIG. 9, there may be provision for the frictional device to exert a force action counteracting the rotation of the secondary side with respect to the primary side not by sliding friction or static friction, but by positive engagement. Thus, for example, teeth could be provided on the primary mass part 86 of FIG. 9 into which corresponding teeth of the thrust ring 114 engage in the activated state. During the activation of this “frictional device” 84, the primary side 22 would then no longer be rotatable with respect to the secondary side 24 at all. This may be utilized, in a state in which a drive assembly is not activated, to bring about this blocking state, so that, during the starting of the drive assembly, the risk that resonant vibrations will be built up due to excessive relative rotation between the primary side and the secondary side is completely eliminated. In order to ensure that appropriate vibration damping is provided, even in the state in which the drive assembly is stopped, an additional frictional device 118 may be provided, which has a permanent or, if appropriate, also protracted action and which may have a markedly lower frictional action because the drive assembly, when stopped, no longer makes a substantial torque contribution for the excitation of vibrations.

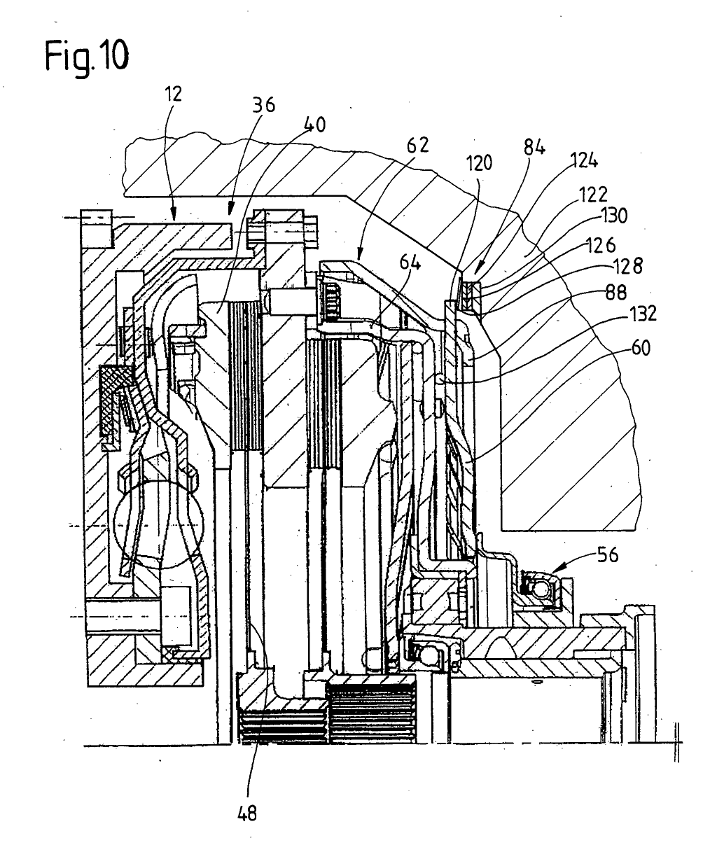

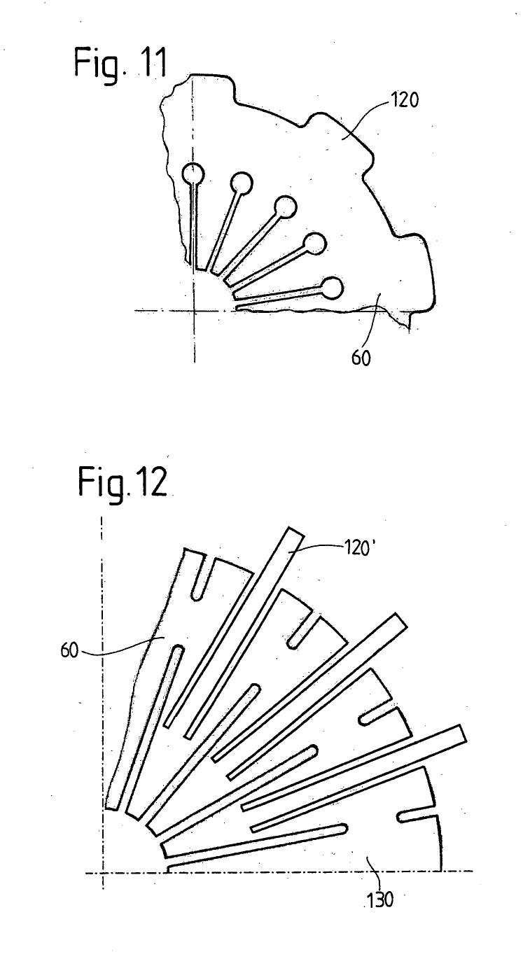

FIG. 10 shows an embodiment in which the frictional device 84 is active or becomes active when the actuating-force transmission arrangement 62 or the actuating system 56 assumes the regulating state E. It can be seen that the force application arrangement 60 has, here, portions 120 which go beyond the bearing contact of this force application arrangement against the component 88 of the actuating-force transmission arrangement 62 and which can also be seen in FIG. 11. A transmission housing 122 or the like has supported on it a friction ring 124 which, under the action of these portions 120 of the force application arrangement 60 and of a thrust ring 126, becomes frictionally active when the state E is reached or a transition into the state E occurs. A cup spring 128 or the like can ensure that the thrust ring 126 and the friction ring 124 remain in a defined installation position, irrespective of the regulating position of the force application arrangement 60. So that frictional heat occurring in this system can be absorbed or discharged in an improved way, a bearing ring 130 composed of metal may be supported on the transmission housing 122.

In the arrangement illustrated in FIG. 10, therefore, the frictional device 84 becomes active when the actuating system 56 is further adjusted in the first clutch region 36 beyond the position C necessary for obtaining the engagement position. This is possible when the axial displacement of the pressure plate 40 and of the actuating-force transmission arrangement 62, coupled to the latter, under the compression of the lining springing 74 of friction linings 52 of the clutch disk 48 is possible, as was described above with reference to FIG. 2. Alternatively, it is also possible to design the force application arrangement 60 in such a way that it is basically elastically deformable, as is also the case with a diaphragm spring, but, furthermore, has radially outward-extending prolonged portions 120′ in the region between the lever portions 130 supported with respect to the housing 64 on the one hand, and to the force application arrangement 62 on the other hand. When the clutch region 36 is in the fully engaged state, in which, for example after the corresponding compression of a lining springing 74, the pressure plate 40 can butt against an axial stop or else the actuating-force transmission arrangement 62 can also butt against a corresponding axial stop, the force application arrangement 60 is further deformed in the region of its lever portions 130 as a result of the further activation or persistent activation of the actuator mechanism 66 of the actuating system 56, so that, as a result of the displacement of the portions 120′ then occurring radially outward, the frictional device 84 can be activated. In this case, to allow this further deformation, the force application arrangement is supported on the housing 64 via a wire ring 132.

It can be seen, as the essential difference of the embodiment according to FIG. 10, that, here, influencing of the secondary side 24 of the torsional-vibration damper arrangement 12 takes place in that the rotation of the latter with respect to a fixed component, to be precise, for example, the transmission housing 122, is influenced, with the result that excitations to vibration which occur in the region of the torsional-vibration damper arrangement 12 can likewise be reduced. It is possible, of course, to combine the embodiment according to FIG. 10 with the embodiments according to FIGS. 3-9, so that the frictional device 84 can be activated both in the engagement state and in the disengagement state of the clutch region 36.

In all the above-described embodiments, the force application arrangement 60 of the first actuating system 56 may be designed both as a diaphragm spring delivering an intrinsic force component or, in general, the engagement force, so that a disengagement force then has to be provided by the actuator mechanism 56 in order to obtain the disengagement state. As outlined above, a lever arrangement may be provided which, although it can be basically elastic, makes no appreciable intrinsic force contribution, so that an engagement force has to be delivered by the actuator mechanism 56. In order to obtain the states B and E, the actuator mechanism can then exert a drawing or pressing action on this force application arrangement in at least one direction.

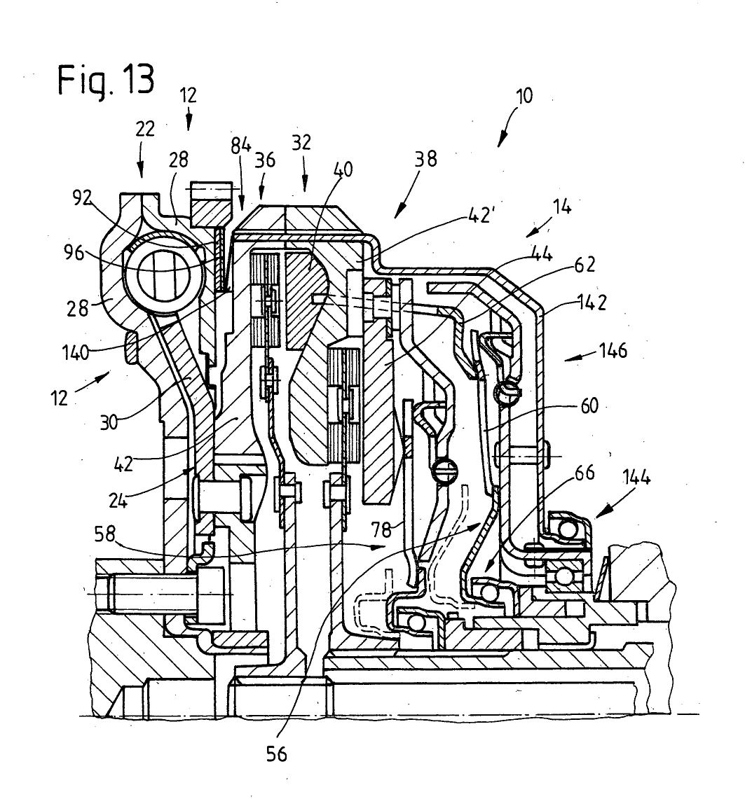

FIG. 13 shows an embodiment in which two axially successive abutment plates 42, 42′ form the abutment regions for the two clutch regions 36, 38, the pressure plates 40, 44 of which are in this case to be displaced in the same axial direction in order to obtain the engagement state. The abutment plate 42 which forms the abutment region of the clutch region 36 is coupled in its radially inner region to the central disk element 30 of the torsional-vibration damper arrangement 12. Between the cover disk element 28 and the abutment plate 42 lies the frictional device 84 which, here too, has a thrust ring 92 and a friction ring 96. These components are held against one another under prestress by a cup spring 140, corrugated spring or the like. A, for example, pot-like actuating-force transmission element 142 passes through orifices provided in the abutment plates 42, 42′ and can be displaced in the axial direction by an actuator mechanism which can be seen merely in the form of an actuator bearing 144. During the activation of this actuating system 146, the actuating-force transmission element 142 presses onto the friction ring 92, so that the latter becomes frictionally active on the thrust ring 96 and contributes again to damping between the primary side 22 and the secondary side 24. It goes without saying that the arrangement of the friction ring and thrust ring may be reversed in the axial direction here.

The advantage of this embodiment is that a third actuating system 146, independent of the actuating systems 56, 58 on the clutch regions 36, 38, is provided for the correspondingly independent activation and deactivation of the frictional device 84, which, of course, here too can completely prevent rotation between the primary side 22 and the secondary side 24 by means of positive engagement or a correspondingly high frictional force.

The torsional-vibration damper arrangement was illustrated above, with reference to the various embodiments, as what is known as a dry-running two-mass flywheel. The torsional-vibration damper arrangement may, of course, also be wet-running, that is to say the damper element arrangement of the latter may dip, at least in regions, into a lubricant chamber designed to be essentially fluidtight radially outward, so that, on the one hand, an additional damping contribution by the displacement of viscous medium can be obtained and, on the other hand, the springs, then designed with a longer circumferential extent, can be supported radially outward, along with a lower sliding friction interaction. Furthermore, it may be pointed out that the various actuator mechanisms of the actuator systems described may take action hydraulically, pneumatically, electrically or else mechanically, so that the corresponding essentially axially directed actuating forces can be generated in them.

The activation of the above-described frictional device for introducing a frictional force influencing the rotational behavior of the secondary side or of the input region of the double clutch or for making a positive connection between the primary side and the secondary side may, of course, also be carried out according to various parameters which characterize operating states. For this purpose, an activating device for the actuator systems may receive corresponding input variables and, based on these, generate activating commands, so that the frictional device can be activated or deactivated.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A torque transmission arrangement for selectively transmitting torque between a drive member and one of a first output member and a second output member, said arrangement comprising:
a torsional vibration damper arrangement comprising a primary side for fixing to said drive member, and a secondary side which is rotatable about an axis of rotation with respect to said primary side counter to the action of a damping arrangement;
a double clutch arrangement coupled to said secondary side and having a first clutch region for selective torque transmission to said first output member and a second clutch region for selective torque transmission to said second output member; and
a selectively activatable rotary state influencing arrangement for limiting the rotational movement of the secondary side with respect to at least one of the primary side and a subassembly which is essentially non-rotatable about said axis of rotation.

2. A torque transmission arrangement as in claim 1 wherein
said first clutch region comprises a first pressure plate and an abutment region coupled to said secondary side, and a first clutch disk arrangement which can be fixed against rotation to said first output member; and
said second clutch region comprises a second pressure plate and an abutment region coupled to said secondary side, and a second clutch disk arrangement which can be fixed against rotation to said second output member;
said double clutch arrangement further comprising a first actuating system for engaging said first clutch region and a second actuating system for engaging said second clutch region.

3. A torque transmission arrangement as in claim 2 wherein said rotary state influencing arrangement can be actuated by at least one of said first and second actuating systems.

4. A torque transmission arrangement as in claim 3 wherein each of said first and second actuating systems is movable in a regulating range for adjusting the respective pressure plate between an engagement position and a disengagement position, said at least one of said first and second actuating systems being movable to a regulating state which is outside of said regulating range for actuating said rotary state influencing arrangement.

5. A torque transmission arrangement as in claim 2 wherein said first actuating system comprises
a force application arrangement which is arranged on a side of the abutment region of the first clutch region which is axially opposite from the first pressure plate, and
an actuating force transmission arrangement for transmitting an actuating force from the force application arrangement to the first pressure plate,
wherein at least one of said force application arrangement and said actuating force transmission arrangement is capable of interacting with at least one of the primary side and a subassembly which is essentially non-rotatable about said axis of rotation in order to limit the rotation of the secondary side with respect to the primary side.

6. A torque transmission arrangement as in claim 2 further comprising a third actuating system for activating said rotary state influencing arrangement.

7. A torque transmission arrangement as in claim 6 wherein said third actuating system comprises:
an actuator region; and
an actuating force transmission member which axially bridges said double clutch arrangement and can be acted on by said actuator region.
